(19) United States
(12) Patent Application Publication
(10) Pub. No.: US 2017/0360648 A1
(43) Pub. Date: Dec. 21, 2017

(54) AIR-SUCTION, HEATING AND VIBRATION PHYSIOTHERAPEUTIC BAR

(71) Applicant: SHENZHEN VALUELINK AND E-COMMERCE CO., LTD., Shenzhen (CN)

(72) Inventors: Qingcao Gan, Shenzhen (CN); Liwei Huang, Shenzhen (CN)

(73) Assignee: SHENZHEN VALUELINK AND E-COMMERCE CO., LTD.

(21) Appl. No.: 15/410,750

(22) Filed: Jan. 19, 2017

(30) Foreign Application Priority Data
Jun. 17, 2016 (CN) 201620590189.9

(51) Int. Cl. A61H 9/00; A61H 23/02

(52) U.S. Cl. CPC A61H 9/0057; A61H 23/02; A61H 2201/0207

(57) ABSTRACT

An air-suction, heating and vibration physiotherapeutic bar, comprises a surface cover, a bottom cover, a DC plug and at least one key. An air pump, a battery, an electronic valve, a PCBA, a motor and a massage device are installed in a space encircled by the bottom cover and the surface cover; the DC plug is electrically connected with the PCBA by a lead; one end of the bottom cover is provided with an air-suction hole; a silica gel suction nozzle of a through hole is sleeved at the air-suction hole; the electronic valve is connected with the air pump by a three-way air tube; the other end of the three-way air tube is connected with the air-suction hole. The air-suction, heating and vibration physiotherapeutic bar of the present invention has simple structure, has physiotherapeutic functions of vacuum air-suction flapping, heating and vibration massage.

### CROSS-REFERENCE TO RELATED APPLICATIONS

This application claims priority to Chinese Patent Application No. 201620590189.9 with a filing date of Jun. 17, 2016, designating the United States, now pending. The content of the aforementioned applications, including any intervening amendments thereto, are incorporated herein by reference.

### TECHNICAL FIELD

The present invention relates to physiotherapeutic equipment, and in particular relates to an air-suction, heating and vibration physiotherapeutic bar.

### BACKGROUND OF THE PRESENT INVENTION

An air-suction bar is equipment which sucks out air in an object so that a low-pressure or vacuum environment is formed inside the object, and can be widely applied in production and life. The air-suction bar realizes air suction by an air pump, and the air pump is controlled by an electronic valve. In the existing air-suction bar, the air pump and the electronic valve are simultaneously controlled by one button, so that the working stability is poor, and the air-suction effect is not satisfactory; in addition, the working mode is single, and the existing air-suction bar can realize air suction only at a constant speed and cannot be adjusted, so the applicability is poor; however, some work requires air suction at different speeds, and the existing air-suction bar only has a single air-suction function and does not have physiotherapeutic effects of simultaneously realizing heating and vibration massage, so the existing air-suction bar cannot meet the use demands of multiple uses.

### SUMMARY OF PRESENT INVENTION

The present invention aims at providing an air-suction, heating and vibration physiotherapeutic bar to solve the problems proposed in the above background, and the air-suction, heating and vibration physiotherapeutic bar has functions of air suction, heating and vibration massage simultaneously or respectively.

In order to achieve the above purposes, the present invention is realized by the technical solution below:

The air-suction, heating and vibration physiotherapeutic bar is in a strip type and comprises a surface cover, a bottom cover, a DC plug and keys, wherein an air pump, a battery, an electronic valve, a PCBA and a massage device are installed in a space encircled by the bottom cover and the surface cover; the DC plug is electrically connected with the PCBA by a lead; the PCBA is electrically connected with the battery, the massage device, the electronic valve and the air pump respectively by the lead; one end of the bottom cover is provided with an air-suction hole; a silica gel suction nozzle of a through hole is sleeved at the air-suction hole; the electronic valve is connected with the air pump by a three-way air tube; the other end of the three-way air tube is connected with the air-suction hole; and the air pump is connected with outside by a substantially L-shaped air tube.

Further, the massage device is fixedly installed at the end of the bottom cover, which is near the air-suction hole.

Further, the massage device comprises a vibration block, a motor and a cam, wherein the vibration block is installed in the middle of air-suction hole by a vibration block fixing part, and the cam drives the vibration block to move up and down.

Further, the left and the right of the top of the vibration block are respectively provided with a vibration block arm, the vibration block arms are clamped in a space formed by the vibration block fixing part and the bottom cover, and the vibration block has a clearance for up-and-down movement in the space formed by the vibration block fixing part and the bottom cover.

Further, the vibration block is horizontally provided with a vibration block groove 532 matched with the cam, the motor drives the cam to rotate, and the cam drives the vibration block to move up and down, so as to achieve the vibration massage effect.

Further, the bottom end of the vibration block is provided with a rotary wheel matched with the bottom cover.

In another preferential solution, the massage device comprises a side rotating gearbox and a screw for fixing the side rotating gearbox, wherein the side rotating gearbox has a massage function.

Further, the silica gel suction nozzle is a hollow annular cavity encircled by a thin wall, and one end of the silica gel suction nozzle is installed at the periphery of the air-suction hole of the bottom cover in a tightening and sealing way.

Further, a heating piece is arranged in the silica gel suction nozzle and is electrically connected with the PCBA by the lead.

Further, the PCBA is installed in the middle of the bottom cover by a PCBA fixing part, the keys are arranged between the PCBA and the bottom cover, the bottom cover is provided with key holes corresponding to the keys, and the keys can respectively control air suction, heating and vibration of the air-suction, heating and vibration physiotherapeutic bar.

Further, an air outlet hole is formed in the middle of the bottom cover, and the air pump is connected with the air outlet hole by the substantially L-shaped air tube.

Further, the air pump is installed at the other end of the bottom cover, which is opposite to the air-suction hole, and the battery is fixedly installed in the middle of the bottom cover.

Further, the bottom cover and the surface cover are installed together in a tightening and sealing way.

According to a physiotherapeutic method of the air-suction, heating and vibration physiotherapeutic bar, the silica gel suction nozzle is in tight contact with skin, the air pump is started to suck air, the skin is in a vacuum suction state, the silica gel suction nozzle is started simultaneously or afterwards to heat, and the motor is started simultaneously or afterwards to drive the vibration block to move up and down, so as to achieve the physiotherapeutic effects of air suction, heating and massage.

Compared with the prior art, the present invention has the beneficial effects that: the air-suction, heating and vibration physiotherapeutic bar has simple structure and reasonable design, has physiotherapeutic functions of vacuum air-suction flapping, heating and vibration massage and is controlled by a switch, the physiotherapeutic functions of vacuum air-suction flapping, heating and vibration massage can be respectively carried out as required, the working stability is good, and the physiotherapeutic effects are enhanced. In addition, the air-suction, heating and vibration physiotherapeutic bar has different physiotherapeutic modes, and the physiotherapeutic modes can be selected according to the actual requirements.

### DESCRIPTION OF THE DRAWINGS

FIG. 1 is a structural schematic diagram of an embodiment I of the present invention;

FIG. 2 is a structural schematic diagram of an embodiment II of the present invention; and

FIG. 3 is a partial section view of a silica gel suction nozzle of the present invention.

Description of drawing marks: 1-surface cover, 2-key, 3-PCBA, 4-electronic valve, 5-massage device, 51-motor, 52-cam, 53-vibration block, 531-vibration block arm, 532-vibration block groove, 54-vibration block fixing part, 55-motor fixing part, 56-rotary wheel, 57-side rotating gearbox, 53-screw, 6-rubber plug hole, 10-lead, 11-battery, 12-PCBA fixing part, 13-air pump, 14-heating piece, 16-three-way air tube, 17-key hole, 18-air outlet hole, 20-substantially L-shaped air tube, 21-DC plug, 22-rubber plug, 23-bottom cover, 24-silica gel suction nozzle, 25-DC socket fixing part, 26-DC socket, 27-DC socket bracket.

### DETAILED DESCRIPTION OF PREFERRED EMBODIMENTS

The technical solution in embodiments of the present invention is clearly and integrally described below in combination with drawings in the embodiments of the present invention. Apparently, the embodiments described are only part of embodiments of the present invention, rather than all embodiments. Based on the embodiments in the present invention, all other embodiments obtained by those skilled in the art on the premise of not doing creative work shall belong to the protection scope of the present invention.

### Embodiment I

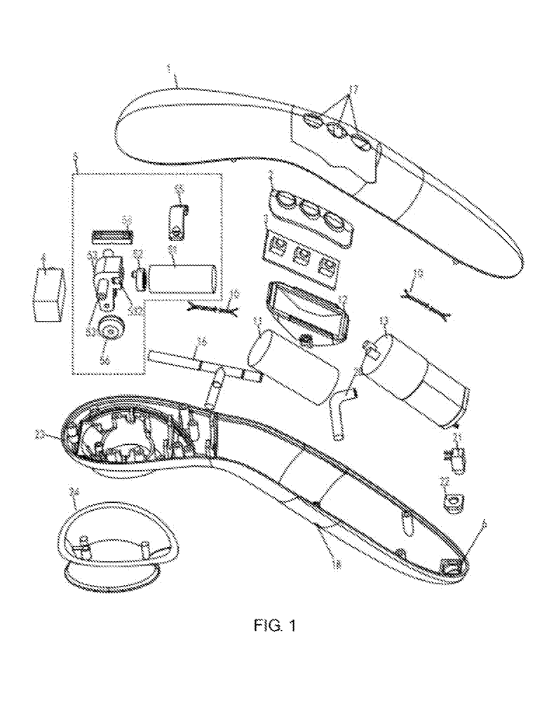

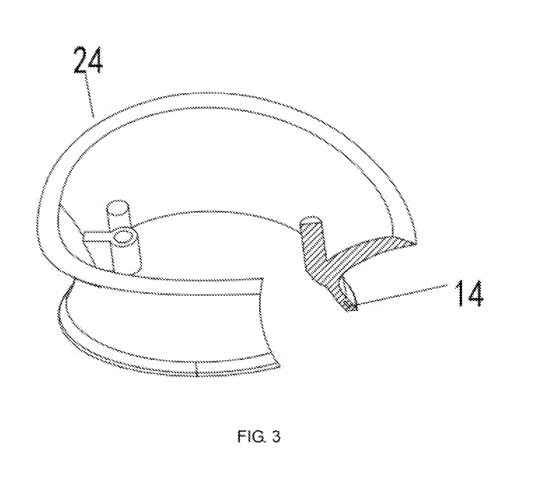

As shown in FIG. 1 and FIG. 3, an air-suction, heating and vibration physiotherapeutic bar is in a strip type and comprises a surface cover, a bottom cover 23, a DC plug 21 and keys 2, wherein an air pump 13, a battery 11, an electronic valve 4, a PCBA 3 and a massage device 5 are installed in a space encircled by the bottom cover 23 and the surface cover 1; the DC plug 21 is electrically connected with the PCBA 3 by a lead 10; the PCBA 3 is electrically connected with the battery 11, the massage device 5, the electronic valve 4 and the air pump 13 respectively by the lead 10; preferably, the battery 11 is chargeable, the DC plug 21 is connected with a mains supply to charge the battery 11, and the battery 11 can supply power to the massage device 5, the electronic valve 4 and the air pump 13 simultaneously; one end of the bottom cover 23 is provided with an air-suction hole; a silica gel suction nozzle 24 of a through hole is sleeved at the air-suction hole; the electronic valve 4 is connected with the air pump 13 by a three-way air tube 16; the other end of the three-way air tube 16 is connected with the air-suction hole; and the air pump 13 is connected with outside by a substantially L-shaped air tube 20.

The massage device 5 is fixedly installed at the end of the bottom cover 23, which is near the air-suction hole, the bottom cover 23 is provided with a groove for supporting and fixing the massage device 5, and the massage device 5 comprises a vibration block 53, a motor 51 and a cam 52.

Preferably, a motor fixing part 55 is sleeved on the motor 51, so that the motor 51 can be fastened on the bottom cover, the vibration block 53 is installed in the middle of the air-suction hole by a vibration block fixing part 54, the left and the right of the top of the vibration block 53 are respectively provided with a vibration block arm 531, the vibration block arms 531 are clamped in a space formed by the vibration block fixing part 54 and the bottom cover, the bottom end of the vibration block 53 is provided with a rotary wheel 56 matched with the bottom cover, the vibration block 53 has a clearance for up-and-down movement in the space formed by the vibration block fixing part 54 and the bottom cover, the vibration block 53 is horizontally provided with a vibration block groove 532 matched with the cam 52, the motor drives the cam 52 to rotate, and the cam 52 drives the vibration block 53 to move up and down, so as to achieve the vibration massage effect.

Preferably, the silica gel suction nozzle 24 is a hollow annular cavity encircled by a thin wall, and one end of the silica gel suction nozzle 24 is installed at the periphery of the air-suction hole of the bottom cover in a tightening and sealing way. The air pump 13 is started to suck air, and the silica gel suction nozzle 24 is in tight contact with skin, so as to form a vacuum state.

Preferably, a heating piece 14 is arranged in the silica gel suction nozzle 24 and is electrically connected with the PCBA 3 by the lead 10. The heating piece 14 is started by the keys 2 to be electrically connected with the battery 11, the heating piece 14 heats, the temperature of the silica gel suction nozzle 24 rises, and the silica gel suction nozzle 24 heats.

Preferably, the PCBA 3 is installed in the middle of the bottom cover by a PCBA fixing part 12, the keys 2 are installed between the PCBA 3 and the bottom cover, the bottom cover is provided with key holes 17 corresponding to the keys 2, the keys 2 are provided with three buttons that can respectively control the silica gel suction nozzle 24 to suck air and the vibration block 53 to vibrate, and the air-suction, heating and vibration physiotherapeutic bar can simultaneously start the physiotherapeutic functions of air suction, heating and vibration massage or respectively has one function or the combination of various functions.

Preferably, an air outlet hole 18 is arranged in the middle of the bottom cover, and the air pump 13 is connected with the air outlet hole 18 by the substantially L-shaped air tube 20.

Preferably, the air pump 13 is installed at the other end of the bottom cover, which is opposite to the air-suction hole, and the battery 11 is fixedly installed in the middle of the bottom cover.

Preferably, a rubber plug hole 6 is arranged at the other end of the bottom cover, which is opposite to the air-suction hole; a rubber plug 22 is sleeved on the rubber plug hole 6; and the DC plug 21 is fastened in the middle of the rubber plug 22.

Preferably, the bottom cover and the surface over are arranged together in a tightening and sealing way.

According to a physiotherapeutic method of the air-suction, heating and vibration physiotherapeutic bar, the silica gel suction nozzle 24 is in tight contact with the skin, the air pump 13 is started to suck air, the skin is in a vacuum suction state, the silica gel suction nozzle 24 is started simultaneously or afterwards to heat, and the motor 51 is started simultaneously or afterwards to drive the vibration block 53 to move up and down, so as to achieve the physiotherapeutic effects of air suction, heating and massage; or the air pump 13 is started to suck air, the silica gel suction nozzle 24 is started simultaneously or afterwards to heat, and the motor 51 is started simultaneously or afterwards to drive the vibration block 53 to move up and down, the silica gel suction nozzle 24 flaps a body part, and a vacuum air-suction state is realized when the silica gel suction nozzle 24 of the air-suction, heating and vibration physiotherapeutic bar is in contact with the skin and can remain for different time lengths, so as to achieve the physiotherapeutic effects of air suction, heating and massage.

### Embodiment II

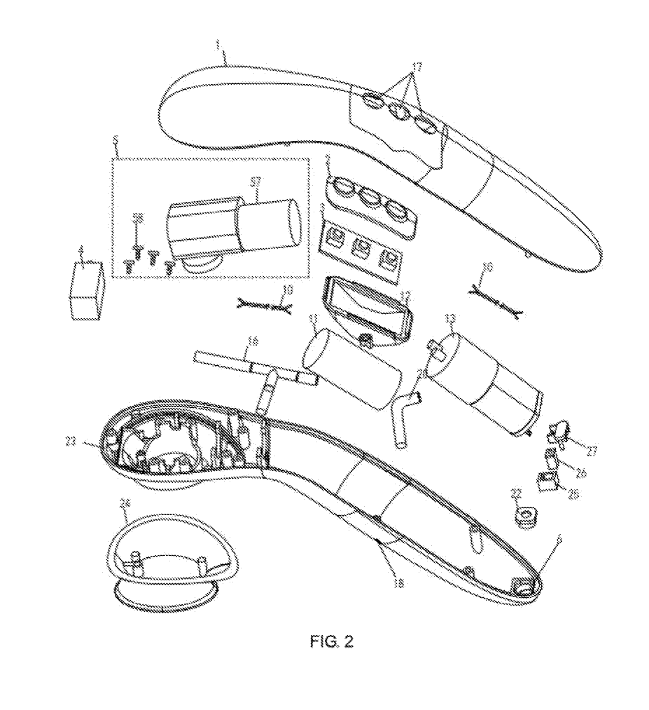

As shown in FIG. 2, the differences between the present embodiment and the embodiment I are described below: a massage device 5 comprises a side rotating gearbox 57 and a screw 58 for fixing the side rotating gearbox 57; the side rotating gearbox 57 has a massage function; a rubber plug hole 6 is arranged at the other end of a bottom cover, which is opposite to an air-suction hole; a rubber plug 22 is sleeved on the rubber plug hole 6; a DC socket 26 is installed in the middle of the rubber plug 22; and the inner end of the rubber plug 22 is also provided with a DC socket fixing part 25 and a DC socket bracket 27 for assisting in fixing the DC socket 26. Others identical with the contents of the embodiment I are not repeated herein.

Apparently, the present invention is not limited to the details of the above exemplary embodiments for those skilled in the art, and the present invention can be realized in other specific forms under the condition of not departing from the spirit or essential features of the present invention. Therefore, the embodiments shall be considered to be exemplary and non-restrictive in any case; the scope of the present invention is limited by the attached claims, rather than the above descriptions; and therefore, the purpose is to include all changes within the meaning and the scope of equivalent elements in the claims into the present invention. Any drawing mark in the claims shall not be regarded as a limit to the involved claims.

In addition, it should be understood that although the description is described according to implementation manners, not every implementation manner only includes one independent technical solution, the description manner of the description is only for clearness, those skilled in the art should regard the description as a whole, and the technical solution in each embodiment can also be properly combined to form other implementation manners that can be understood by those skilled in the art.

We claim:

1. An air-suction, heating and vibration physiotherapeutic bar, in a strip shape, comprising:
a surface cover, a bottom cover, a DC plug and at least one key;
wherein an air pump, a battery, an electronic valve, a PCBA and a massage device are arranged in a housing encircled by the bottom cover and the surface cover; the DC plug is electrically connected with the PCBA by a lead; the PCBA is electrically connected with the battery, the massage device, the electronic valve and the air pump respectively by the lead; one end of the bottom cover is provided with an air-suction hole; a silica gel suction nozzle of a through hole is sleeved at the air-suction hole; the electronic valve is connected with the air pump by a three-way air tube; a other end of the three-way air tube is connected with the air-suction hole; and
the air pump is connected with outside by a substantially L-shaped air tube.

2. The air-suction, heating and vibration physiotherapeutic bar of claim 1, wherein the massage device is fixedly installed at the end of the bottom cover and near the air-suction hole.

3. The air-suction, heating and vibration physiotherapeutic bar of claim 1, wherein the massage device comprises a vibration block, a motor and a cam; the vibration block is installed in the middle of the air-suction hole by a vibration block fixing part, and the cam is configured to drive the vibration block to move up and down.

4. The air-suction, heating and vibration physiotherapeutic bar of claim 3, wherein a left and a right side of the top of the vibration block are respectively provided with a vibration block arm; the vibration block arm is clamped in a space formed by the vibration block fixing part and the bottom cover; and the vibration block has a clearance for up-and-down movement in the space formed by the vibration block fixing part and the bottom cover.

5. The air-suction, heating and vibration physiotherapeutic bar of claim 3, wherein the vibration block is horizontally provided with a vibration block groove matched with the cam; the motor is configured to drive the cam to rotate, and the cam is configured to drive the vibration block to move up and down to achieve vibration massage effect.

6. The air-suction, heating and vibration physiotherapeutic bar of claim 1, wherein the massage device comprises a side rotating gearbox and a screw for fixing the side rotating gearbox; and the side rotating gearbox has a massage function.

7. The air-suction, heating and vibration physiotherapeutic bar of claim 1, wherein a heating piece is arranged in the silica gel suction nozzle and is electrically connected with the PCBA by the lead.

8. The air-suction, heating and vibration physiotherapeutic bar of claim 1, wherein the PCBA is installed in the middle of the bottom cover by a PCBA fixing part; the at least one key is installed between the PCBA and the bottom cover, the bottom cover is provided with at least one key hole matching with the at least one key; and the at least one key is configured to control air suction, heating and vibration of the air-suction, heating and vibration physiotherapeutic bar.

9. The air-suction, heating and vibration physiotherapeutic bar of claim 1, wherein the bottom cover and the surface cover are installed together in a tightening and sealing way.
